(19) United States
(12) Patent Application Publication
(10) Pub. No.: US 2001/0026551 A1
(43) Pub. Date: Oct. 4, 2001

(54) Arrangement and method relating to packet switching

(76) Inventor: Dan Horlin, Enskede (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/796,086

(22) Filed: Feb. 28, 2001

Related U.S. Application Data
(63) Continuation of application No. 09/072,672, filed on May 6, 1998, now abandoned.
Application No. 09/072,672 is a continuation of application No. PCT/SE96/01413, filed on Nov. 4, 1996.

(30) Foreign Application Priority Data
Nov. 9, 1995 (SE) 9503966-5

(51) Int. Cl. H04L 12/28

(52) U.S. Cl. 370/389; 370/395; 370/412

(57) ABSTRACT

An arrangement and a method control the flow of signals including a number of information packets in a communications network, e.g. an ATM-network. The arrangement includes a device for separating the signals in the first traffic signals and second traffic signals. The first traffic signals are signals that have a higher proportion of guaranteed resources, i.e. bandwidth, than the second traffic signals. The first traffic signals are also given a lower priority than the second traffic signals. The first and second traffic signals are handled separately.

### TECHNICAL FIELD

The present invention relates to a packet switching arrangement for switching information packets between a number of input links and a number of output links.

The invention also relates to a packet switch for switching packets from an input side to an output side thereof for packets having mixed or different quality of service QoS.

The invention also relates to a method of switching information packets from input links to output links via a switch core.

Still further the invention relates to a method of controlling the flow of ATM (Asynchronous Transfer Mode) cells through a switching arrangement.

### STATE OF THE ART

In communications systems information can be transported in the form of packets. Information can thus be said to be collected or grouped in a number of units, i.e. divided into a number of units. Each packet comprises a data field and a header. The header is the preamble of a packet and it contains address information such as destination address, possibly origination ad dress etc. but also control bits. A cell is a short packet having a predetermined number of bits and cells are used for systems operating in ATM-mode.

Packets (or cells) are in now existing communications systems routed from an origination to a destination via a number of packet switches. The address information in the header is used by the switches for routing the packets to, or in the direction of, the correct destination.

However, the amount of packets incoming to a packet switch can be very high since there may be many input links connected to the switch. There may also be a high number of output links connected to the switch. Altogether the switching procedure is complicated and difficult to handle. A switch may operate in synchronous transfer mode (STM) or in asynchronous transfer mode (ATM). In STM a so called frame reference is assumed which is a common time reference, among different terminals. Each slot in a frame is used for the connection between two terminals.

In ATM packets or cells are transported by each terminal without time reference.

Generally for a packet switch in operation it is possible that a number of packets from different destinations arrive at the switch at the same time via different input links which for example may have the same output link as their destination. There may also be a high number of input links but merely a limited number of output links so that the input links compete. However, an output link cannot handle but one packet or cell at a time. This means that the other packet (or packets) must be stored temporarily in a buffer. If however many packets are addressed to the same output link, the buffering capability may not be sufficient but packets may even be lost. Even if there is room in the buffer, one or more packets must stay in a queue in the buffer during one or more time slots while repeatedly doing attempts to be switched. While generally referring to packets, it should be clear that cells are meant in the case of ATM.

Of course many different attempts have been done to solve these problems and further problems related thereto.

Packet switching can be done using different buffering methods. According to a first method input buffering is used which means that the packets are buffered on the incoming links, i.e. on the input side. A number of input links may then be connected to each an input buffer, the output of these input buffers going to a switching matrix or a switch core. Packets are then written into and read from each input buffer on a first in, first out (FIFO) basis at a rate corresponding to the capacity of the input links. Input buffers can be implemented quite easily and input buffers having a large capacity can be built. However, in the case as referred to above, a number of packets which each are the first in the respective queue, may have the same destination. Then only one buffer can be dealt with at a time. While one buffer is served, the packets in the other buffers having the same destination will have to wait as well as consecutive packets in these latter buffers which have or may have other destinations. This means that the capacity of the switch will not be used in an optimal way. One way of alleviating these problems has been to provide the switch with output buffers wherein an output buffer is provided for each outgoing link. Then packets from the incoming links can be written into the buffer of the addressed output link. However, in this case a number of packets may arrive substantially at the same time from a number of different input links or even all. This puts high demands on the output buffers and they are required to have a bandwidth which is enough for writing data from all input links at a speed at which no packets are lost. This is complicated since for example ATM switches may operate at data rates of e.g. 150 Mbits/s. It is clear that at high rates, in order to avoid losses of packets, very high requirements are put on the buffers, otherwise losses will have to be accepted.

To summarize, switching arrangements are known which use only input buffers, only output buffers or a combination of both. A most frequently used switching arrangement has applied the principle of switching packets into the switch core in a given order and then a free output buffer is searched for by the switch core. It is also known to stop the switching of packets if the output buffers get overfilled and cannot accept more packets. If moreover the switching components of a network are expected to handle services of different quality of service, different QoS, this means that a separation of different queues depending on QoS is required in the buffers since packets having different QoS put different requirements on the queues. In the worst case it may be necessary to have a queue separation, i.e. a number of different queues depending on QoS, for the inlet port or inlet unit of a switch due to the traffic concentration from different input links, a further queue separation for the switch core due to the traffic concentration towards the outlet ports or outlet units of the switch and still a further queue separation towards the outlet unit or outlet part of the switch due to the traffic concentration towards different output links. This makes the switching arrangement both complicated and expensive.

WO 94/14266 discloses a flow control system for packet switches including input buffers as well as output buffers. A detecting device is connected to each output buffer to detect high buffer content. The status of the fullness of the output buffer is continuously-transmitted to an access device. The access device comprises at least one input buffer and throttling means. Thus, when the fullnes level of any of the output buffers, exceeds a predetermined level, the traffic to that output buffer is stopped and stored in the input buffer on the link concerned. This document, however, does not provide any solution when packets have different QoS.

Furthermore, it is based on throttling having the drawbacks as discussed above.

U.S. Pat. No. 5,079,762 shows an ATM switching system which uses waiting buffers for routing high QoS cells during congested traffic. However, also this system involves a complicated switching arrangement and does not in a satisfactory way solve the problems.

### SUMMARY OF THE INVENTION

What is needed is therefore a switching arrangement and a switching method respectively which is simple and easy to fabricate and implement and for which the implementation costs are low.

Moreover a switching arrangement etc. is needed which has a high capacity, which to largest extent possible avoids losses of packets and which can handle information with different QoS without deteriorating or affecting the QoS and which can operate in ATM-mode.

A switching arrangement is also needed wherein the capacity of the switch can be used fully or almost fully.

Therefore a switching arrangement and a switching method respectively are provided wherein information packets on a number of input links are switched through a switch core to a number of output links. The destination address is given by the packets. It should again be noted that for ATM-mode the packets are in the form of cells. Main buffering means are arranged on the input side in which the packets are stored in different queues. The switch core comprises a registering arrangement which contains information on the sending status of each of a number of inlet units to each of which a number of input links are connected. The receiving ability of the output links is directly or indirectly monitored by monitoring means and the switch core is provided with information relating to the receiving ability thereof which information e.g. indicates when an output link is able to receive a packet.

Using this information the switch core finds an inlet unit which is able to send a packet. Means are also provided for finding a queue in a main buffering means from which a packet may be sent. Advantageously each of, or at least a number of, the output links each comprises a separate, small output buffer. The receiving ability of these small output buffers is then detected or monitored to provide information about the receiving capability of the corresponding output link. The monitoring means may particularly comprise a number of first signalling arrangements of which each monitors the output buffers of the output links of an outlet unit. In an advantageous embodiment the switch core may also comprise a second signalling arrangement particularly comprising a number of second signalling units, one for each outlet unit wherein the first signalling unit provides the corresponding second signalling unit with information about the receiving ability of an output buffer. More particularly still the second signalling unit may establish a connection between an inlet unit able to send a packet and an output buffer able to receive a packet. The second signalling unit particularly establishes via the registering arrangement of the switch core whether an inlet unit is able to send a packet and if so, which inlet unit. Advantageously the arrangement is connection oriented. In an advantageous embodiment the switch core comprises a number of small core buffers, one core buffer for each outlet unit.

Moreover, advantageously the inlet unit able to send a packet selects a queue from among the queues present in the main buffering arrangement or particularly the main buffering unit corresponding to that particular inlet unit. In each main buffering unit the incoming packets can particularly be arranged in queues at least depending on QoS. Of course the queues may also be arranged depending on other criteria or on further criteria as well. Advantageously, a packet is only switched through the switch core if it has been established that the switching from the input side to the output side, i.e. from the inlet unit to the particular output buffer really can be completed. In an advantageous embodiment, information about which category of packets, or even more particularly which QoS, that can be accepted by the output buffer, is provided to the inlet unit via the signalling arrangements or via the switch core.

The packets are particularly so called ATM-cells, i.e. the switch operates in ATM-mode.

A packet switch for switching packets from an input side with a number of inlet units to an output side is also provided. To each inlet unit a main buffering unit is arranged. In each main buffering unit incoming packets on a number different input links are arranged in a number of queues. The arranging in different queues is due to the packets being of different categories, for example they may have different QoS but they can also be arranged on the basis of other criteria such as output link etc. To each output link a small buffer unit is arranged on the output side and means are provided for detecting if any of the output buffers is capable of receiving a packet and if so, a free inlet unit is found, or searched for, so that the switching through the switch core is controlled by the capability of receiving packets of the output buffer. Most advantageously information is provided via the switch core to the inlet unit about which category of packet, e.g. which QoS (or QoS:s) can be received by the particular output buffer so that the inlet unit can search for a queue holding packets of that particular QoS and thus send a packet from that queue to the output buffer if such is available. Advantageously, when an output buffer and an inlet unit as referred to above have been found, a connection is established between the inlet unit and the output buffer. Thereupon the inlet unit founds an appropriate queue. A packet from the particular queue is only switched to the output if it can be switched all the way through.

A method of switching information packets from input links to output links via a switch core is also provided. A main buffer unit is provided on the input side to each of a number of inlet units. Each of a number output links is also provided with a small output buffer. When an output buffer able to receive a packet is found, the switch core is informed about that. Via the switch core is then searched for free inlet unit which is able to send a packet. A connection is set up through the switch core between the free inlet unit and the output buffer able to receive a packet and if an appropriate packet is found by the inlet unit,, the packet is switched to the output buffer.

Advantageously packets incoming on input links are arranged in different queues in the respective main buffer units depending on category such as QoS:s etc. Most advantageously the input unit is provided with information about which category or categories that can be received by the output buffer and the inlet unit selects a queue depending on the given information. The switch particularly operates in ATM-mode.

The concept of the invention is applicable irrespective of used flow controlling methods. In a advantageous embodiment however a flow controlling arranged as described in the simultaneously and by the same applicant filed patent application “Arrangement and method of packet flow control” which is incorporated herein by reference.

It is an advantage of the invention that the queue arranging and handling is concentrated to the input side of the switch. It is another advantage of the invention that the switch core is small and easy to implement.

Yet another advantage of the invention is that no switching occurs until it is established that there is a route through the switch to an output buffer, which gets even more advantageous as the number of categories or particularly the number of QoS:s is high.

It is also an advantage that the capacity of the switching arrangement is used in an efficient way and that no packets/cells unnecessarily have to wait in queues.

### BRIEF DESCRIPTION OF THE DRAWINGS

The invention will in the following be further described in a non-limiting way under reference to the accompanying drawings in which:

FIG. 1 illustrates one embodiment of a switching arrangement according to the invention,

FIG. 2 is a schematical flow diagram describing the switching procedure.

### DETAILED DESCRIPTION OF THE INVENTION

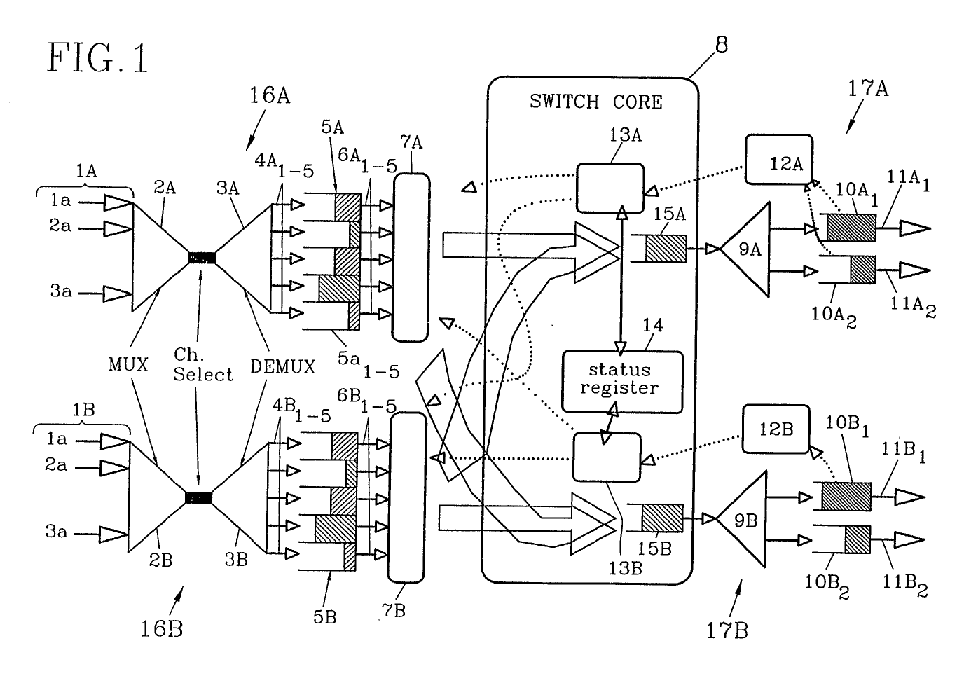

In FIG. 1 a switching arrangement comprising a switch core 9 and two inlet ports 16A, 16B with two inlet units 7A, 7B is illustrated. (The description mainly refer to data information transfer from input ports to output ports, however, data information can also be transferred in the opposite direction). Information packets are incoming on a number of incoming links 1a, 2a, 3a; 1b, 2b, 3b. The packets are coming in from different terminals having different grades of service or mixed quality of service QoS. The input links 1A, 1B (1a,2a,3a;1b,2b,3b) of inlet ports 16A, 16B are concentrated or multiplexed in the multiplexers 2A, 2B respectively and a channel selection is carried out as indicated in the figure wherein it is merely schematically indicated where a multiplexed channel selection e.g. of the type ATM VP/VC (Virtual Path/Virtual Channel) may take place. In a demultiplexer 3A, 3B a demultiplexing is carried out at least per QoS. A demultiplexing may also be done relating to outport 17A, 17B, i.e. splitting up per outport, for point to multipoint connections or in relation to other criteria or categories; either one or more. The information packets on the connection links 4A₁₋₅ are arranged in a main buffering unit 5A in a number of different queues 5A₁₋₅ and the same applies for the connection links 4B₁₋₅. The main buffer units 5A, 5B are comparatively large and thus have capability of storing many information packets when needed.

An information packet may for example be an ATM-call. The packets may contain information either in one form or different packets may contain information of different kinds. The information may for example take the form of data, video, voice, image etc. From the main buffer units 5A and 5B respectively the packets, which hereinafter will be denoted cells referring to this particular embodiment, can be fetched by the respective inlet unit 7A, 7B, although the invention of course applies to packets in a more general sense. A simple switch core 8 is provided which comprises a registering arrangement 14 or a status register and among others the sending status of the inlet units is collected. In this particular embodiment the switch core 8 comprises a small core buffer 15A, 15B for each outlet port 17A, 17B or outlet unit 9A, 9B. The switch core 8 moreover comprises second signalling means 13A, 13B, the functioning of which however will be explained more fully after the description relating to the output side of the switch core 8. The switching arrangement comprises two output ports 17A, 175 respectively. The output ports 17A, 17B comprise each an outlet unit 9A, 9B receiving cells from the switch core 8. From each outlet unit 9A, 9B there are two output links 8A_{1.2}; 8B_{1.2}. To each output link a small output buffer 10A₁, 10A₂; 10B₁, 10B₂ is arranged. Signalling means in the form of a first and a second signalling unit 12A, 12B; 13A, 13B respectively are arranged for monitoring/detecting the queue status in the respective output buffers of the corresponding outlet unit.

The first signalling units 12A, 12B provide the second signalling units 13A, 13B, wherein a first signalling unit cooperates with the corresponding second signalling unit of the same output port, with information.

In the status register 14 information is stored about the current status of the input units 7A, 7B and the second signalling unit 13A, 13B which has received information from a first signalling unit 12A, 12B that an output buffer is able to receive an information packet, i.e. here a cell, searches in the status register 14, input unit by input unit, to find a free input unit i.e. an input unit which is not sending but which at least theoretically could send a cell. Signalling is in the figure illustrated by dashed lines.

The information from a first signalling unit that an output buffer is able to receive a cell may advantageously also contain further information relating to which categories, or in this particular case which QoS:s that can be received. This information is received in the second signalling unit which passes on the information to a found free inlet unit. The registering arrangement 14 or particularly the status register contains information on sending and not sending inlet units respectively. Moreover the register may comprise various prioritizing functions which can be more or less complicated. This will however not be further described herein since the functioning of such registering arrangements is known per se and the registering arrangement is chosen depending on the particular application and the needs and requirements thereof.

An inlet unit 7A; 7B that has been informed about a free output buffer 10A₁, 10A₂; 10B₁, 10B₂ checks the queues of the corresponding main buffer 5A; 5B to see whether there is any queue in the buffer corresponding to that particular QoS (of course more than one QoS could be acceptable by the output buffer for example there can be an upper or a lower limit relating to QoS etc). If a cell of the corresponding QoS is found in the main buffer 5A; 5B, a connection is established between the free inlet unit 7A; 7B and the output buffer 10A₁, 10A₂; 10B₁, 10B₂ able to receive a cell. A cell can then be switched through the switch core 8 to the concerned output buffer 10A₁, 10A₂; 10B₁, 10B₂.

Thus the switch core can keep the input ports informed about the traffic concentration status for different QoS:s.

In the embodiment as shown in FIG. 1 the switch care 8 merely comprises a number of small core buffers 15A, 153, one for each outlet unit 9A, 9B. This means that cells of different QoS can go through the same core buffer without the QoS being negatively affected thereby. Through the use of a small buffer 15A, 15B, speed adaptation is enabled and it also facilitates implementation of the switch ports since it allows at least to some extent misfits between an inport and an outport.

A cell can be fetched from an inlet unit 7A, 7B at the same time as the switch core 8 delivers a preceding cell to an outlet unit 9A; 9B.

The second signalling units 13A, 13B receive signals from the first signalling units 12A; 12B and search the status register 14 to find a free input port or inlet unit. Of course the signalling units 12A, 12B; 13A, 13B can also have other functions in the cooperation between the registering arrangement and the second signalling unit may also take any other convenient form, i.e. the second signalling unit could find a free inlet unit in any convenient way other than by going through all the inlet units one by one etc.

The status register 14 can for example provide the second signalling unit with information on a free inlet as soon as it receives a signal from the second signalling unit that a free inlet unit is needed etc. However, when a free inlet unit has been found, the second signalling unit may for example send a status word to inform the inlet unit on which QoS that is receivable or which QoS:s that can be received. The inlet unit may then either send a cell to the output buffer or immediately reject. Thus it can be said that the signalling units of the output buffers control the traffic flow. As already mentioned above, it does not have to be QoS that is used for controlling purposes but it may be based on other criteria. The meaning of QoS is here only an internally configured relation for the switch core between inport and outport.

The signalling and the corresponding queue handling on the input side can for example be used for separating different ATM QoS or for separating different output links. In another embodiment it may relate to the separation of a numerically high number of connections from a numerically low number of connections or for separating connections from each other depending on their arranging into a priority scheme or simply to separate important connections from non-important or less important connections. It is obvious that also a number of other alternatives or any combination of alternatives is possible.

The invention will now be described under reference to a particular case, also under reference to FIG. 1.

As illustrated in FIG. 1 the first signalling unit 12A which monitors the queue status or the fullness of the output buffers 10A₁, 10A₂. Detection or monitoring can of course be done in any convenient manner of which a number of different methods are known per se. A number of different conditions may form the basis for the result to be transmitted to the switch core 8. For example it may be enough that the output buffer can receive one cell or a packet or any given number of cells or packets or packets of a given size or packets of a given QOS etc. This can be seen as two different aspects, one relates to the different QoS or different categories as referred to above and a second relates to other criteria such as for example a group of buffer units having to be able to receive packets in order to provide a signal or to initiate the sending of one or more packets etc. The latter aspect is however not important or necessary for the functioning of the present invention; it is merely mentioned to illustrate that also other conditions etc. may apply.

According to the embodiment described herein, the first signalling unit 12A, monitors the queue status of the output buffer 10A₂. The queue status information is transmitted to the second signalling unit 13A as signalling information in headers sent in the reverse direction. If the status is that the output buffer 10A₂ is able to receive a cell from the switch core 8, a free inlet unit will be searched for. In this case, the first signalling unit 12A reports the queue status to the second signalling unit 13A of the switch core 8. According to another embodiment, it is however possible that signalling only occurs if there is free buffer space, i.e. if a cell actually can be received. In the status register 14 information is gathered on which inlet units currently are free or not free respectively. This means that they are sending or not sending respectively. As referred to above this register may comprise more or less advanced functions relating to priorities etc. The signalling unit 13A carries out a search in the status register 14 to find a free inlet unit. If the second signalling unit 13A finds a free inlet unit, in this case it is supposed that inlet 7B is free, this is reserved for a connection towards the output buffer 10A₂. A connection is then established.

The reserved inlet unit 7B then selects a QoS queue of the receivable kind from the main buffering unit 5B and checks whether it contains any cells which could be switched to the output buffer 10A₂. If the selected QoS queue contains such a cell, the cell is switched to the output buffer 10A₂ if it can be switched. Otherwise no switching occurs. The second signalling unit 13A is then informed on the result of the transmission, e.g. that the transmission has been successful.

As can be seen from the above description the queue handling of the switch actually takes place in a free inlet unit and the corresponding main buffering unit and it is actually the signalling unit of the outport that controls the traffic flow. Thus the switch core can handle QOS signalling in combination with a small queue on the output side why the queue handling as referred to above is concentrated to the input port, in short also referred to as inport.

It is an advantage that the buffers responsible for the actual queue handling is concentrated to the input ports since this enables very low implementation cost since particularly in connection with a mixed QoS wherein partly (for at least some of these QoS:s) flow regulation of the type ATM ABR is required. Furthermore the size of the switch core can be kept very small. This is further discussed in the patent application “Arrangement and method relating to packet flow control” as referred to earlier. In said document e.g. ATM ABR signals are discussed. Such signals are difficult to handle in an efficient way e.g. as far as flow controlling is concerned since they as such comprises two types of signals namely those being guaranteed a significant proportion of bandwidth and those being not. Then the flow control of said document can most advantageously be combined with the switching according to the present application.

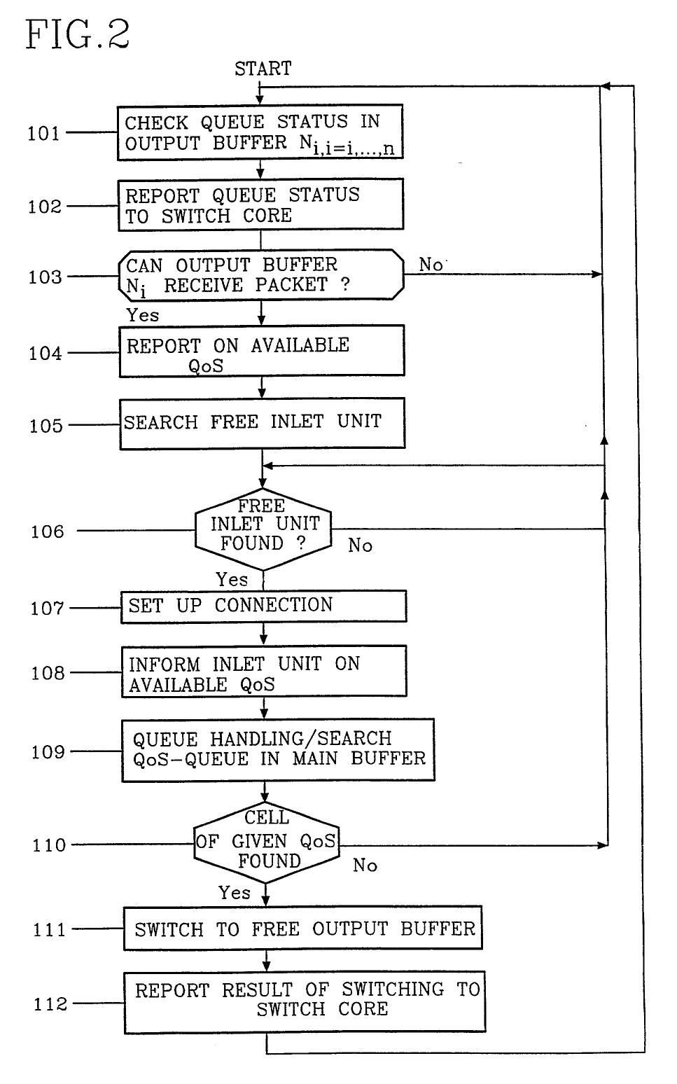

In FIG. 2 a schematical flow diagram is shown in order to facilitate the understanding of the invention. 101 indicates that the queue status is checked for input buffer Ni, wherein “i” indicates the number of a particular output link for a given output port. The queue data is forwarded to the switch core, 102. There is established whether the output buffer Ni is able to receive a packet. If it can not, the queue status of the next output buffer is checked i.e. i=i+1 etc. If however it is detected that the output buffer N₁ can receive a packet, available QoS(s) is/are reported to the switch core 104, i.e. in this case the second signalling unit of the switch core. A search 106 has to be done to find a free inlet unit, advantageously the second signalling unit carries out a search through the intermediary of a status register 105. If no free inlet unit is found, either the search for a free inlet unit is continued or another output buffer is monitored to see if it can receive a packet. If on the other hand a free inlet unit is found, a connection is set up 107. The found inlet unit is then informed about available QoS of the output buffer 108. In 109 the queue handling is then initiated by the inlet unit searching for a queue for cells or packets of (any of) the corresponding QoS in the main buffer unit of said inlet unit. In 110 is established whether there is any queue for cells of the corresponding QoS and thus whether a convenient cell has been found. If this is not the case, the procedure may either be to search for a free inlet unit or according to another embodiment to check the queue status of the next output buffer.

The found cell is then switched to the output buffer, in 112 the result of the switching is reported to the switch core.

It should however be clear that the invention can be varied in a number of different ways. The invention is of course not limited to embodiments wherein there are only two ports but there can be any other convenient number of ports. Two ports are merely used to exemplify the invention for reasons of clarity.

1. A packet switching arrangement for switching information packets between a number of inlet units (7A,7B) receiving information packets from a number of input links (1A,1B) and a number of outlet units (9A,9B) connecting to a number of output links (11A₁,11A₂,11B₁,11B₂) said arrangement comprising:
main buffering means (5A,5B) arranged on the input side for storing information packets from the input links in a number of queues, characterized in, that the arrangement further comprises:
a switch core (8) comprising a registering arrangement (14) for registering the sending status of the inlet units (7A,7B),
means for detecting/monitoring (12A,12B;13A,13B) the receiving ability of the output links (11A₁,11A₂,11B₁,11B₂) and for providing the switch core (8) with information thereon,
means for setting up a connection between an inlet unit able to send an information packet and an output link able to receive a packet, the main buffering means comprising a number of main buffering units (5A,5B), in each main buffering unit the incoming packets being arranged in queues at least depending on QoS and in that means are provided for selecting from the queues in the main buffer units (5A,5B) a queue from which an information packet can be sent.

2. The arrangement of claim 1, characterized in, that wherein at least a number of output links (11A₁,11A₂,11B₁,11B₂) each comprises a separate, small output buffer (10A₁,10A₂,10B₁10B₂).

3. The arrangement of claim 2, characterized in, that the means for detecting/monitoring (12A,12B) the receiving ability of the output links are arranged-to detect/monitor the queue status of the output buffers (10A₁,10A₂,10B₁10B₂).

4. The arrangement of claim 3, characterized in, that the means for detecting/monitoring the queue buffers comprises a first signalling arrangement (12A,12B) for monitoring the output buffers (10A₁,10A₂,10B₁10B₂) of the output links.

5. The arrangement of claim 4, characterized in, that the first signalling arrangement comprises a number of first signalling units (12A,12B), one for each outlet unit (9A,9B).

6. The arrangement of claim 5, characterized in, that the switch core (8) comprises a second signalling arrangement and wherein the first signalling units (12A,12B) provide said second signalling arrangement with information on the receiving ability of the output buffers.

7. The arrangement of claim 6, characterized in, that the second signalling arrangement comprises one second signalling unit (13A,13B) for each outlet unit (9A,9B), wherein a first signalling unit of a particular outlet unit communicates with the second signalling unit of the same outlet unit.

8. The arrangement of claim 7, characterized in, that a second signalling unit (13A,13B) assists in establishing a connection between an output buffer able to receive a packet and an inlet unit able to send a packet.

9. The arrangement of claim 8, characterized in, that the second signalling unit establishes via the registering arrangement (14) whether there is any inlet unit able to send a packet upon receiving information from a signalling unit about an output buffer able to receive a packet.

10. The arrangement of anyone of the preceding claims, characterized in, that the inlet unit (7A, 7B) provides f o r selection among the queues in the main buffer units (5A,5B) of the buffering arrangement.

11. The arrangement of claim 10, characterized in, that there is one main buffering unit (5A,5B) for each inlet unit (7A, 7B).

12. The arrangement of anyone of the preceding claims, characterized in, that in the switch care (8) comprises a number of small core buffer memories (15A,15B), one per outlet unit (9A,9B) at least for a number of outlet units.

13. The arrangement of claim 12, characterized in, that only if a switching from an input unit to an output buffer can be completed, a packet from a selected queue is switched through the switch core (8).

14. The arrangement of claim 12 or 13, characterized in, that the small core buffers memories, e.g. handle speed conversion, minor non-perfect cooperating conditions etc.

15. The arrangement of anyone of claims 1-14, characterized in, that the QoS for at least a number of input packets is different.

16. The arrangement of claim 15, characterized in, that the signalling unit of an output buffer able to receive a packet, provides the switch core (8) with information on which QoS that can be received, which information is communicated to an inlet unit able to send a packet.

17. The packet switching arrangement as in anyone of claims 1-16, characterized in, that the switching arrangement operates in asynchronous transfer mode (ATM).

18. The packet switching arrangement of claim 16 or 17, characterized in, that the information packets comprise ATM cells.

19. The packet switching arrangement of claim 18, characterized in, that at least part of the ATM cells are ATM ABR cells.

20. A packet switch for switching packets from an input side with a number of inlet units (7A,7B) to an output side, characterized in, that a main buffer unit (5A,5B) is arranged to each inlet unit (7A,7B) in which main buffer units (5A,5B) incoming packets are arranged in a number of queues e.g. depending on QoS and in that small buffer units (10A₁,10A₂,10B₁,10B₂) are arranged for each output link (11A₁,11A₂,11B₁,11B₂), means furthermore being provided for finding a free inlet unit (7A,7B) once an output link or output buffer unit (10A₁,10A₂,10B₁,10B₂) has been found which is able to receive a packet.

21. The packet switch of claim 20, characterized in, that the means for finding an inlet unit able to send a packet comprises signalling means (12A,12B,13A,13B) and storing means (14) for temporarily storing information about inlet units (7A,7B) currently available for sending packets wherein further information about which QoS can be received is provided to said inlet unit (7A,7B) which selects a queue in the main buffer unit (5A,5B) holding that QoS.

22. The packet switch of claim 20 or 21, characterized in, that the packets comprise ATM cells.

23. An ATM switching arrangement for switching cells from an input side to an output side of a packet switch, the input side comprising a number of inlet units (7A,7B), characterized in, that to each inlet unit (7A,7B) a main buffering unit (5A,5B) is arranged in which main buffer units (5A,5B) cells can be sorted at least depending on QoS and wherein to each of a number of output links a small output buffer (10A₁,10A₂,10B₁,10B₂) is arranged respectively, a signalling unit being provided for each outlet unit (9A,9B) which controls the traffic flow through the switch by providing information to the switch core (8) of the switching arrangement about which output link can receive which kind(s) of cell(s), in response to which information an input unit (7A,7B) is found which is free for sending.

24. The ATM switching arrangement of claim 23, characterized in, that the input means (7A,7B) selects a cell to be switched depending on the information received from the receiving output buffer of the output link.

25. A method of switching information packets from input links to output links via a switch core, the method comprising the steps of:
providing a main buffer unit on the input side to each of a number of inlet units,
providing each of a number of output links with a small output buffer,
informing the switch core when an output buffer can receive a packet,
finding a free inlet unit able to send a packet,
setting up a connection through the switch core,
switching the packet through the switch core.

26. The method of claim 25 further comprising the steps of:
arranging incoming packets in queues corresponding to given categories in the main buffer units,
providing the input unit with information about which category/categories (QoS) that can be received in the output buffer,
the inlet unit selecting a queue depending on the information from the output buffer relating to receivable categories.

27. The method of claim 25 or 26, characterized in, that the switch operates in asynchronous transfer mode ATM.

28. A method of controlling the flow of incoming ATM cells comprising the steps of:
arranging buffering means before each of a number of inlet units arranged on the input side of the switch core,
providing each output link with a small output buffer,
when a particular output buffer is able to receive a cell of a particular category, such a cell is searched,
setting up a connection through the switch core,
switching the cell to the particular output buffer.
